(19) United States
(12) Patent Application Publication
(10) Pub. No.: US 2026/0168636 A1
(43) Pub. Date: Jun. 18, 2026

(54) LAMP UNIT AND VEHICLE LAMP

(71) Applicant: Ichikoh Industries, Ltd., Isehara-shi (JP)

(72) Inventor: Yasuhiro OKUBO, Isehara-shi (JP)

(73) Assignee: Ichikoh Industries, Ltd., Isehara-shi (JP)

(21) Appl. No.: 19/103,753

(22) PCT Filed: Aug. 23, 2023
(86) PCT No.: PCT/JP2023/030289

§ 371 Date: Feb. 13, 2025

(30) Foreign Application Priority Data
Aug. 31, 2022 (JP) 2022-138568

(51) Int. Cl. F21S 41/27

(52) U.S. Cl. CPC F21S 41/27

(57) ABSTRACT

A lamp unit that can form an illumination pattern near a vehicle is provided without increasing the vertical dimension. A vehicle lamp using the same is also provided. A lamp unit includes, an installation base unit with light sources, a converging lens that converges light from the light sources, a light blocking member with slit units allowing partial passage of the light converged by the converging lens, and a projection lens that projects the light delivered through the light blocking member, to form an illumination pattern having illumination figures, which are arranged along a lamp unit axis. The projection lens and light blocking member are rotated downward about a reference focal point set on the lamp unit axis, and the installation base unit and converging lens are rotated downward about an installation base unit reference point set behind and above the reference focal point.

### TECHNICAL FIELD

The present disclosure relates to a lamp unit and a vehicle lamp.

### BACKGROUND ART

Vehicle lamps that uses a lamp unit to form an illumination pattern on a road surface around a vehicle are known (see, for example, PTLs 1 and 2). These conventional lamp units can form an illumination pattern by projecting, through a projection lens, light that has been emitted by a light source and passed through a slit unit in a light blocking member (shade), and thereby can inform viewers of intention expressed by the illumination pattern.

### CITATION LIST

### Patent Literature

PTL 1: Japanese Unexamined Patent Application Publication No. 2020-102332

PTL 2: Japanese Unexamined Patent Application Publication No. 2019-192349

### SUMMARY OF THE INVENTION

### Problems to be Solved by the Invention

A vehicle lamp is commonly installed in a vehicle such that a lamp unit and the like are arranged along a vehicle axis set on the vehicle, and a dimension of the vehicle lamp in an up-down direction perpendicular to the vehicle axis is desired to be reduced.

However, conventional vehicle lamps include, for forming an illumination pattern on a road surface, a lamp unit which is a combination of a light source, a light blocking member, and a projection lens and which is provided to have a lamp unit axis inclined downward toward the road surface. Such a configuration of the conventional vehicle lamps increases the substantial dimension of the lamp unit in the up-down direction.

The present disclosure has been made in consideration of the above-mentioned circumstances, and an object thereof is to provide a lamp unit that can form an illumination pattern in the vicinity of a driver's vehicle without increasing the dimension in the up-down direction and to provide a vehicle lamp using the lamp unit.

### Means for Solving the Problem

A vehicle lamp according to the present disclosure includes, an installation base unit provided with a plurality of light sources, a converging lens that converges light from the plurality of light sources, a light blocking member provided with a plurality of slit units that allows partial passage of the light that has been converged by the converging lens, and a projection lens that projects the light that has passed through the light blocking member, to form an illumination pattern having a plurality of illumination figures corresponding to the plurality of slit units, and the installation base unit, the converging lens, the light blocking member, and the projection lens are arranged along a lamp unit axis. In the vehicle lamp, the projection lens has a reference focal point set on the lamp unit axis, the projection lens and the light blocking member are rotated downward about the reference focal point, and the installation base unit and the converging lens are rotated downward about an installation base unit reference point set behind and above the reference focal point.

### Effect of the Invention

According to the vehicle lamp of the present disclosure, it is possible to form an illumination pattern in the vicinity of a driver's vehicle without increasing the dimension in the up-down direction.

### BRIEF DESCRIPTION OF THE DRAWINGS

FIG. 1 is an explanatory diagram illustrating a vehicle on which vehicle lamps of a first example according to the present disclosure are installed, and each of the vehicle lamps forms an illumination pattern.

FIG. 2 is an explanatory diagram illustrating a lamp unit in the vehicle lamp as viewed from a projection lens side in an axial direction.

FIG. 3 is an explanatory diagram illustrating the lamp unit as viewed in a width direction.

FIG. 4 is an explanatory exploded view illustrating a configuration of the lamp unit.

FIG. 5 is an explanatory diagram illustrating a cross section taken along a line I-I illustrated in FIG. 2.

FIG. 6 is an explanatory diagram illustrating a positional relationship between a first light source and a second light source in a light source unit.

FIG. 7 is an explanatory diagram illustrating configurations and a positional relationship of a first slit unit, a second slit unit, and a third slit unit in a shade.

FIG. 8 is an explanatory diagram illustrating a converging lens as viewed from the light source unit side.

FIG. 9 is an explanatory diagram illustrating the converging lens as viewed from the shade side.

FIG. 10 is an explanatory diagram illustrating light traveling in the lamp unit as viewed from an upper side in the up-down direction, and light from the first light source enters the first lens unit from an inclined incident surface, is reflected by a reflecting surface, passes through the shade (the first slit unit and the second slit unit of the shade), and travels toward a projection lens.

FIG. 11 is an explanatory diagram illustrating luminous flux distribution in a first illumination area formed on the shade by light from the first light source that has entered the first lens unit from the inclined incident surface, been reflected by the reflecting surface, and then exited from an outer exit surface unit.

FIG. 12 is an explanatory diagram illustrating light traveling in the lamp unit as viewed from the upper side in the up-down direction, and light from the first light source enters the first lens unit from a facing incident surface, passes through the shade (the first slit unit and the second slit unit of the shade), and travels toward the projection lens.

FIG. 13 is an explanatory diagram illustrating luminous flux distribution in a second illumination area formed on the shade by light from the first light source that has entered the first lens unit from the facing incident surface, and exited from an inner exit surface unit.

FIG. 14 is an explanatory diagram illustrating light traveling in the lamp unit as viewed from the upper side in the up-down direction, and light from the second light source enters the second lens unit from a second incident surface, passes through the shade (the third slit unit of the shade), and travels toward the projection lens.

FIG. 15 is an explanatory diagram illustrating luminous flux distribution in a third illumination area formed on the shade by light from the second light source that has entered the second lens unit from the second incident surface, and exited from a second exit surface.

FIG. 16 is an explanatory diagram illustrating distribution on a projection lens of light from a first lens unit of a converging lens of a lamp unit of a first comparative example.

FIG. 17 is an explanatory diagram illustrating distribution on the projection lens of light from a second lens unit of the converging lens of a lamp unit of a first comparative example.

FIG. 18 is an explanatory diagram illustrating distribution on the projection lens of light from the first lens unit of the converging lens of the lamp unit of the first example.

FIG. 19 is an explanatory diagram illustrating distribution on the projection lens of light from the second lens unit of the converging lens of the lamp unit of the first example.

### MODE FOR CARRYING OUT THE INVENTION

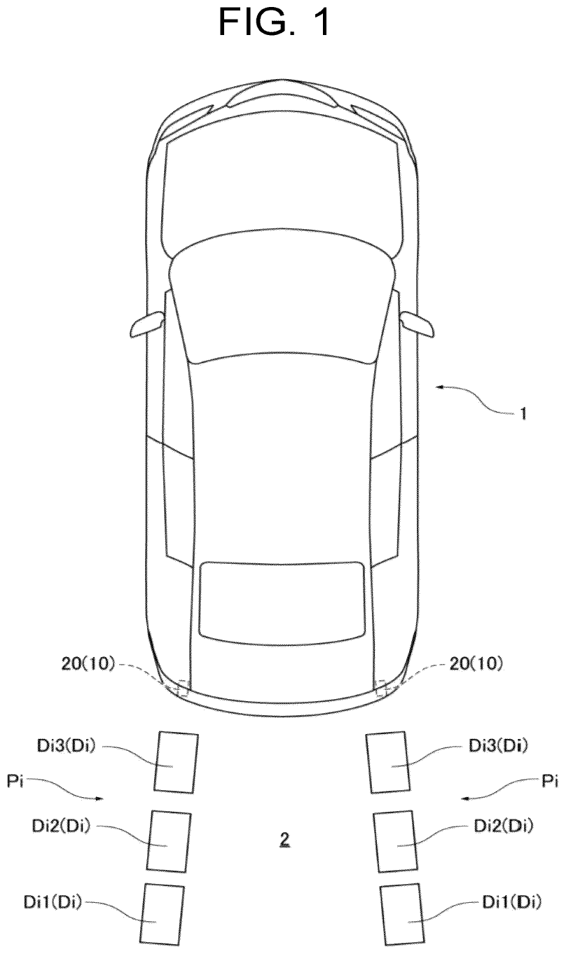

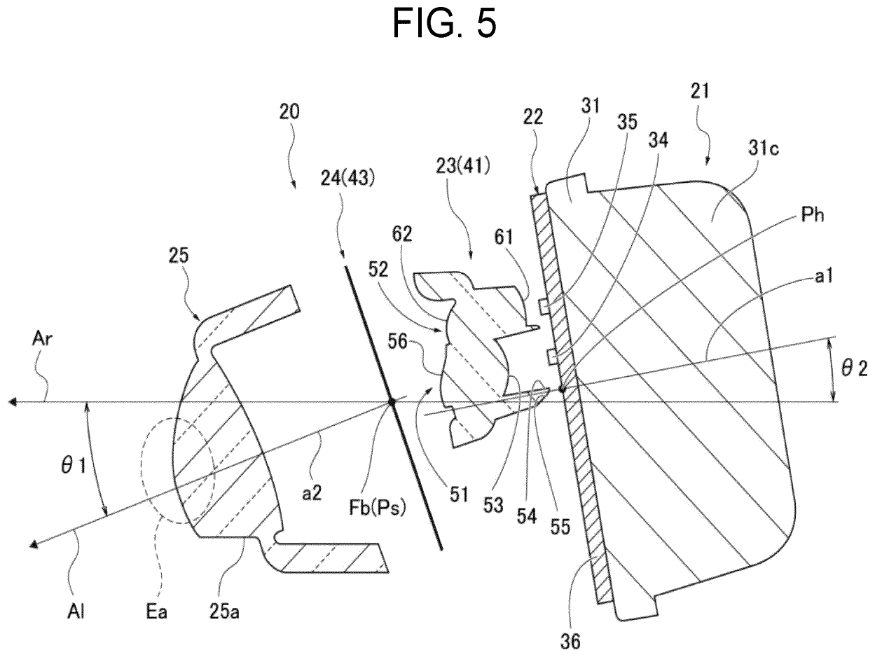

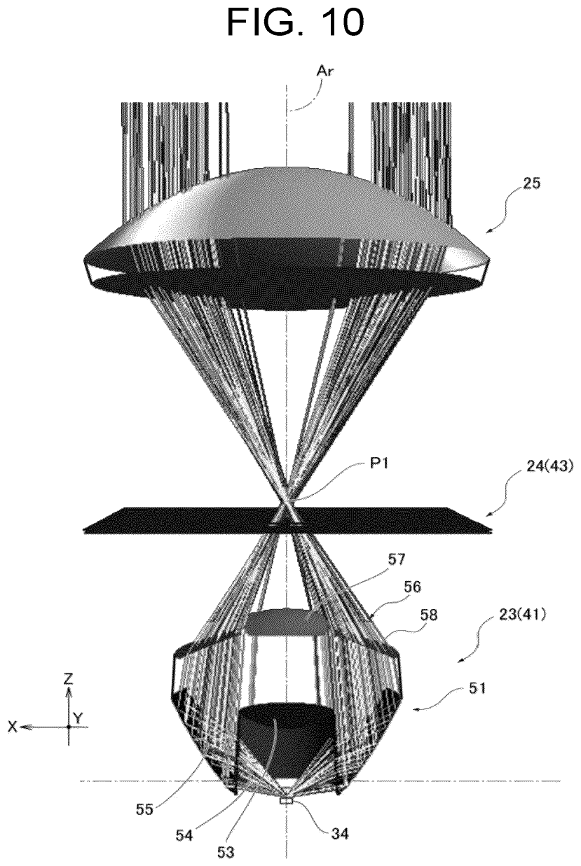

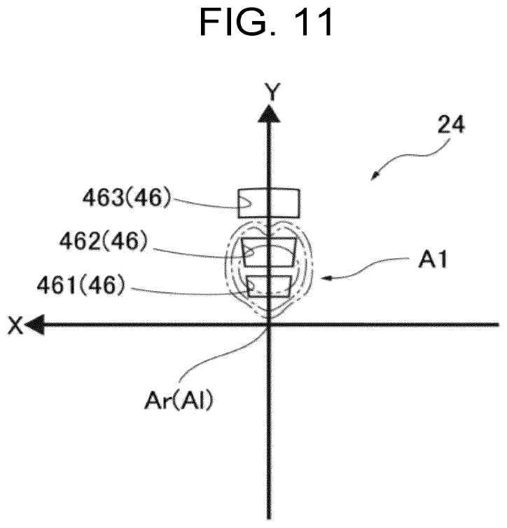

As an example of a vehicle lamp according to the present disclosure, a first example of a lamp unit 20 and a vehicle lamp 10 will be described below with reference to the drawings. In FIG. 1, to make it easier to understand how the vehicle lamp 10 is provided, the vehicle lamp 10 is illustrated in an exaggerated manner relative to the vehicle 1, and the actual appearance may be different. In addition, in FIG. 5, slit units 46 of a shade 24 are not illustrated. Furthermore, in FIGS. 10, 12, and 14, to make it easier to understand how light travels, the shade 24 is illustrated diagrammatically, and some parts of the converging lens 23 that have greater optical influence, i.e. a facing incident surface 53, an inclined incident surface 54, a reflecting surface 55, an inner exit surface unit 57, an outer exit surface unit 58 of a first lens unit 51, a second incident surface 61 and a second exit surface 62 of a second lens unit 52, and an incident surface and an exit surface of a projection lens 25 are illustrated in an exaggerated manner. In each of FIGS. 11, 13, and 15, illumination (luminous flux) distribution is illustrated using sections each delimited by a line and having a corresponding luminous flux amount (light amount), and thus the distribution appears like contour lines and the luminous flux increases toward the center.

### First Example

The vehicle lamp 10 of the first example according to an embodiment of a vehicle lamp according to the present disclosure will be described with reference to FIGS. 1 to 19. As illustrated in FIG. 1, the vehicle lamp 10 according to the first example is used as a lamp for a vehicle 1 (driver's vehicle) such as an automobile. The vehicle lamp 10 is provided at the rear part of the vehicle 1, to form an illumination pattern Pi on a road surface 2 of a surrounding area behind the vehicle 1, separately from signal lamps such as back lamps (stop lamps) and turn lamps provided on the vehicle 1. The surrounding area behind the vehicle 1 is expressed by a legally determined distance from the vehicle 1, and is, for example, an area within 3 m from the vehicle 1.

In the first example, the vehicle lamps 10 are provided as signal lamps such as back lamps and turn lamps provided on the vehicle 1, and in the first example, the vehicle lamps 10 are provided as a pair of left and right back lamps at the rear of the vehicle 1. The vehicle lamps 10 may be configured as other signal lamps, such as a clearance lamp, a turn lamp, or a tail lamp, and is not limited to the first example. The two vehicle lamps 10 have basically the same configuration except for the difference in the mounting position and the position where the illumination pattern Pi is formed, and therefore will be simply described as the vehicle lamp 10 below.

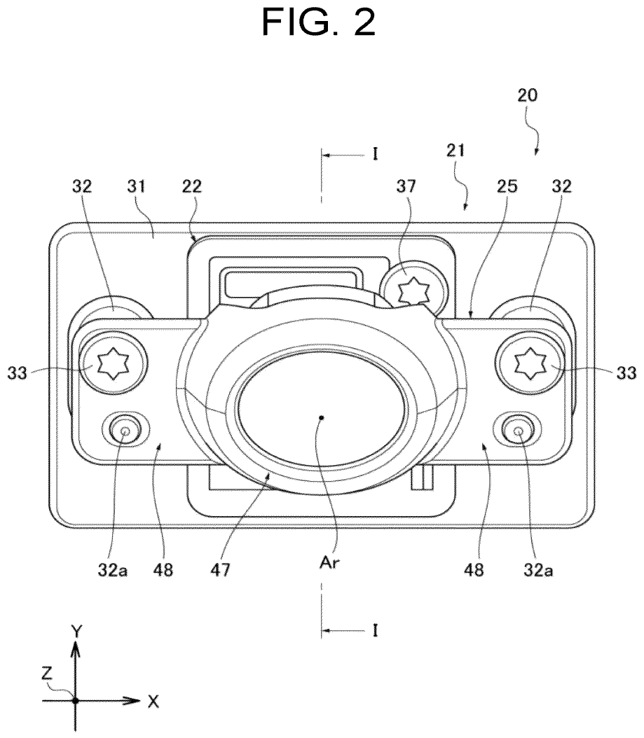

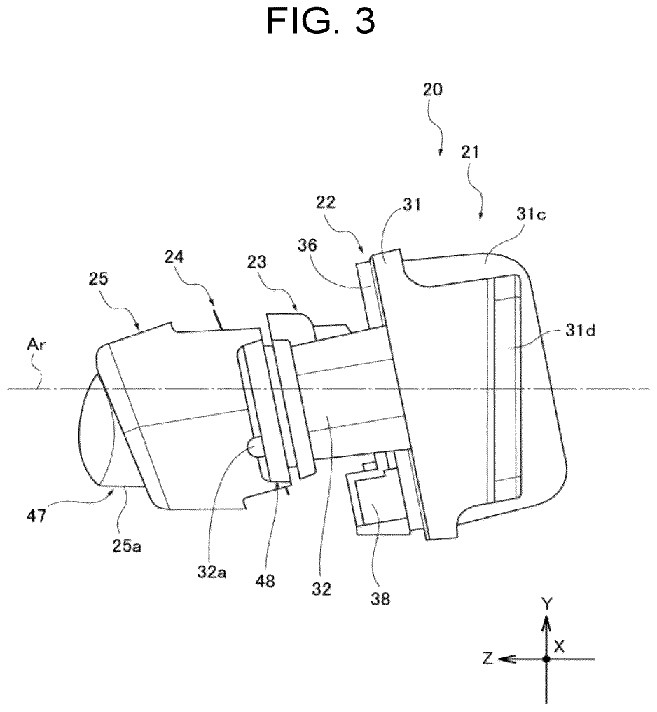

The vehicle lamp 10 has a configuration in which a signal lamp unit and the lamp unit 20 are provided within a lamp chamber enclosed by a lamp housing and a lamp lens. In the first example, the vehicle lamp 10 is disposed at a position higher than the road surface 2 at the front end of the vehicle 1. In the vehicle lamp 10, the lamp unit 20 (see FIGS. 2, 3, etc.) is provided such that a lamp unit axis Ar is substantially parallel to the road surface 2. The lamp unit axis Ar is an axis parallel to a vehicle axis set on the vehicle 1, and serves as a positional reference for attaching each member of the lamp unit 20. In the following description, in the lamp unit 20, the direction in which the lamp unit axis Ar extends is defined as an axial direction (denoted as Z in the drawings), the vertical direction when the axial direction extends along a horizontal plane is defined as an up-down direction (denoted as Y in the drawings), and the direction perpendicular to the axial direction and the up-down direction (the horizontal direction) is defined as a width direction (denoted as X in the drawings) (see FIGS. 2, 3, etc.).

As illustrated in FIGS. 2 to 5, in the lamp unit 20, a light source unit 22, the converging lens 23, the shade 24, and the projection lens 25 are attached to an installation base unit 21. The lamp unit 20 is a single projection optical system and forms a projector-type road surface projection unit. The installation base unit 21 is where the light source unit 22 is provided, and is made of thermally conductive die-cast aluminum or resin, and functions as a heat sink as a whole to release heat generated by the light source unit 22 to the outside. The installation base unit 21 has a base unit 31 and a pair of attachment arm units 32.

The base unit 31 is in the form of a flat plate, and the light source unit 22 is attached to a light source attachment location at the center of the base unit 31. This light source attachment location is a flat surface, and is provided with two screw holes 31a and two positioning protrusions 31b. Further, the base unit 31 is provided with a plurality of heat dissipation fins 31c, and heat generated in the light source unit 22 installed at the light source attachment location dissipates mainly from each of the heat dissipation fins 31c to the outside. An attachment rib 31d is provided in the outermost one of the heat dissipation fins 31c in the width direction (see FIG. 3). The attachment rib 31d is shaped in the form of an elongated rod extending in the up-down direction and perpendicularly to the lamp unit axis Ar. The attachment rib 31d of the base unit 31 is used to attach the installation base unit 21 to the vehicle lamp 10 such that the lamp unit axis Ar is parallel to the vehicle axis.

The pair of attachment arm units 32 are provided on both outer sides of the light source unit 22 in the width direction, and protrude from the base unit 31 toward the front side in the axial direction and perpendicularly to the base unit 31. The end units of both the attachment arm units 32 on the front side in the axial direction are formed as flat surfaces perpendicular to the protruding direction of the attachment arm units 32 (an installation base unit reference axis al described later). Each of the end units is provided with a positioning protrusion 32a and a screw hole 32b. In the end unit of each of the attachment arm units 32, the positioning protrusion 32a is provided at the lower part in the up-down direction of the end unit, and protrudes forward in the axial direction. In the end unit of each of the attachment arm units 32, the screw hole 32b is provided at the upper part in the up-down direction of the end unit. The converging lens 23, the shade 24, and the projection lens 25 can be fixed by screwing screws 33 into the screw holes 32b.

As illustrated in FIG. 5, in the installation base unit 21, an installation base unit reference point Ph is set at or near a substrate 36 (described later) of the light source unit 22 attached to the base unit 31. In the installation base unit 21, a line passing through the installation base unit reference point Ph and perpendicular to the substrate 36 (the light source attachment location) is defined as the installation base unit reference axis al. The installation base unit reference point Ph is set above the lamp unit axis Ar in the up-down direction. Further, since the installation base unit reference point Ph is located at or near the substrate 36, the installation base unit reference point Ph is set to be located more to the rear in the axial direction (the direction in which the lamp unit axis Ar extends) than a reference focal point Fb, which will be described later. Since this installation base unit reference point Ph is located at or near the substrate 36, the installation base unit reference point Ph is positioned between the installation base unit 21 and the converging lens 23. Note that the installation base unit reference point Ph can be set at any location, as long as the installation base unit reference point Ph is located between the installation base unit 21 and the converging lens 23. Here, the phrase “between the installation base unit 21 and the converging lens 23” is not limited to the space between the installation base unit 21 and the converging lens 23, but also includes positions overlapping with the installation base unit 21 or the converging lens 23. The installation base unit 21 has the installation base unit reference axis a1 inclined relative to the lamp unit axis Ar, and accordingly, the substrate 36 (the light source attachment location) is inclined relative to the lamp unit axis Ar. The inclination of the installation base unit reference axis a1, i.e., the installation base unit 21 (substrate 36), will be described later.

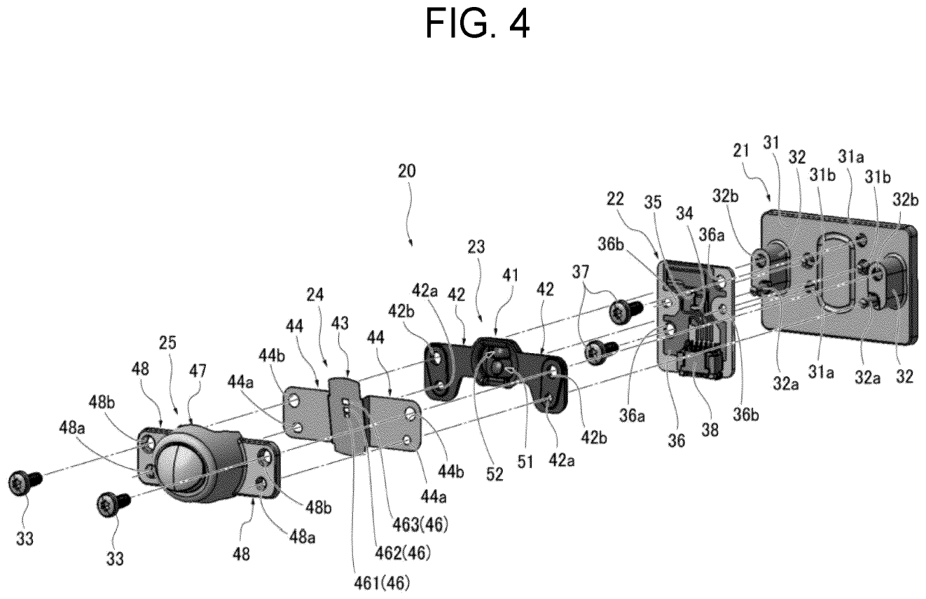

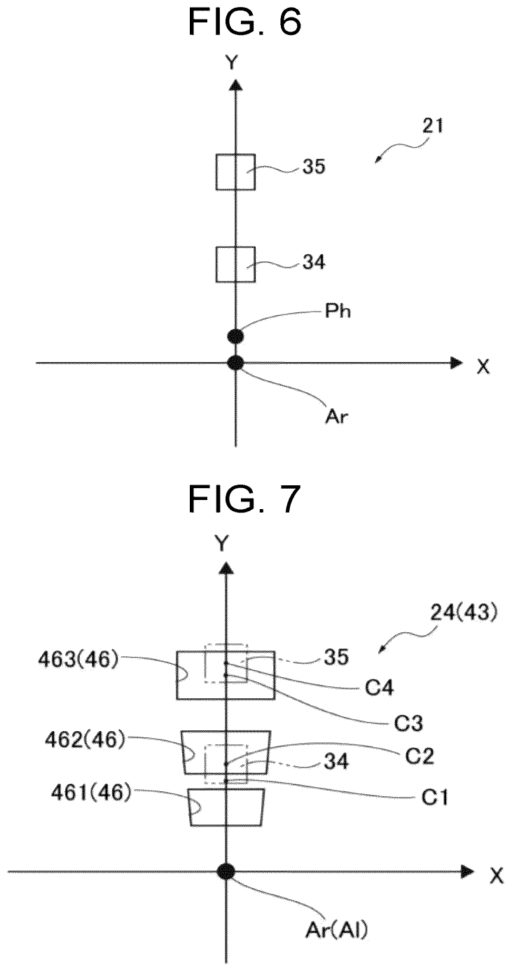

As illustrated in FIG. 4, FIG. 5, etc., the light source unit 22 has a first light source 34, a second light source 35, and the substrate 36 on which the first light source 34 and the second light source 35 are mounted. The two light sources (34, 35) are light emitting elements such as Light Emitting Diodes (LEDs). In the first example, the two light sources (34, 35) emit white color light (white light) to form a Lambertian distribution centered on the emission optical axis. The colors (wavelength bands), distribution patterns, number of colors, and the like of the two light sources (34, 35) may be appropriately set, and are not limited to the configuration of the first example. As illustrated in FIG. 6 and the like, the two light sources (34, 35) of the first example are located above the lamp unit axis Ar and are arranged in the up-down direction. The first light source 34 is located closer to the lamp unit axis Ar, and the second light source 35 is located above the first light source 34. In the first example, both the light sources (34, 35) are located above the installation base unit reference axis a1 and are formed into a substantially square shape.

The substrate 36 is in the form of a plate and made of a resin material such as a glass epoxy substrate, and the light sources (34, 35) are mounted on the substrate 36. The substrate 36 is provided with two screw through holes 36a each corresponding to one of the screw holes 31a at the light source attachment location of the base unit 31 of the installation base unit 21, and also with two positioning holes 36b each corresponding to one of the positioning protrusions 31b at the light source attachment location. The substrate 36 is attached to the base unit 31 by inserting each of the positioning protrusions 31b through the corresponding positioning hole 36b and screwing each of the screws 37 inserted through the corresponding screw through hole 36a, into the corresponding screw hole 31a. As a result, each of the light sources (34, 35) mounted on the substrate 36 faces the converging lens 23.

The substrate 36 is provided with connector terminals 38 which are electrically connected to a wiring pattern. The connector terminals 38 are provided at a lower edge of the substrate 36 in the up-down direction to facilitate attachment and detachment of a connector. Once a connector is attached to the connector terminals 38, power from a lighting control circuit can be supplied to each of the light sources (34, 35) via the wiring pattern. Therefore, the substrate 36 appropriately supplies power from the lighting control circuit via the connector terminal 38 to appropriately turn on each of the light sources (34, 35).

The converging lens 23 converges the light emitted from each of the light sources (34, 35) and causes the light to converge around each of the slit units 46 described later of the shade 24, i.e., in an area of the shade 24 in which each of the three slit units 46 is provided. The converging lens 23 includes a converging lens body 41 that converges light from each of the light sources (34, 35), and a pair of converging lens attachment piece units 42 extending from the converging lens body 41 in the width direction. The converging lens body 41 and the converging lens attachment piece units 42 are integrally formed, and in the first example, are integrally formed by using resin molding. The converging lens body 41 has optical characteristics set to form a predetermined illumination area on the shade 24. This will be described later.

Both the converging lens attachment piece units 42 are formed into a flat plate shape, and can be brought into contact with the end units of both the attachment arm units 32 of the base unit 31 of the installation base unit 21. Each of the converging lens attachment piece units 42 is provided with a converging lens positioning hole 42a and a converging lens screw through hole 42b. When the converging lens attachment piece units 42 are in contact with the end units of the attachment arm units 32, the positioning protrusions 32a can be fitted into the converging lens positioning holes 42a. When the converging lens attachment piece units 42 are in contact with the end units of both the attachment arm units 32, the screws 33 to be screwed into the respective screw holes 32b can be passed through the respective converging lens screw through holes 42b. The converging lens 23 is attached to both the attachment arm units 32 (end units thereof) of the installation base unit 21 by inserting the positioning protrusions 32a through the respective converging lens positioning holes 42a, and screwing each of the screws 33 inserted through the corresponding converging lens screw through hole 42b, into the corresponding screw hole 32b.

The shade 24 is an example of a light blocking member that allows partial passage of the light from each of the light sources (34, 35) that has been converged by the converging lens 23, through each of the slit units 46 described later, to form the illumination pattern Pi. As illustrated in FIG. 1, the illumination pattern Pi has three illumination figures Di aligned at substantially equal intervals in a direction away from the vehicle 1. Here, when each of the illumination figures Di is referred individually, the one furthest from the vehicle 1 is referred to as a first illumination figure Di1, the second furthest to the vehicle 1 is referred to as a second illumination figure Di2, and the third furthest to the vehicle 1 is referred to as a third illumination figure Di3. In the first example, the illumination figures Di each have a substantially rectangular shape with a shorter side facing the vehicle 1, have substantially the same size and shape, and are arranged at substantially equal intervals.

This illumination pattern Pi is formed by the first illumination figure Di1, the second illumination figure Di2, and the third illumination figure Di3 arranged on the road surface 2, which is a projection surface, along the same straight line extending away from the vehicle 1. Therefore, by arranging three illumination figures Di, the illumination pattern Pi can be recognized as a line of light extending in the direction in which the illumination figures Di are arranged. The illumination pattern Pi consisting of the three illumination figures Di is formed by the shade 24.

As illustrated in FIG. 4, FIG. 7, and the like, the shade 24 is basically formed of a plate-like member that does not transmit light, and includes a shade unit 43 and a pair of shade attachment piece units 44. The shade attachment piece units 44 extend on both sides in the width direction from the shade unit 43 and can be brought into contact with the respective converging lens attachment piece units 42 of the converging lens 23 attached to the end units of both the attachment arm units 32 of the installation base unit 21. Each of the shade attachment piece units 44 is provided with a shade positioning hole 44a and a shade screw through hole 44b. When the shade attachment piece units 44 are in contact with the converging lens attachment piece units 42, the positioning protrusions 32a can be fitted into the respective shade positioning holes 44a. When the shade attachment piece units 44 are in contact with the converging lens attachment piece units 42, the screws 33 to be inserted through the respective converging lens screw through holes 42b can be passed through the respective shade screw through holes 44b. The shade 24 is attached to both the attachment arm units 32 of the installation base unit 21 with the converging lens 23 interposed therebetween, by inserting the positioning protrusions 32a through the respective shade positioning holes 44a, and screwing each of the screws 33 inserted through the corresponding shade screw through hole 44b, into the corresponding screw hole 32b.

As illustrated in FIG. 5, the shade 24 has a shade reference point Ps set at the center position of the shade unit 43, and a line passing through the shade reference point Ps and perpendicular to the shade unit 43 is defined as a shade reference axis a2. Once the shade attachment piece units 44 of the shade 24 are attached to both the attachment arm units 32, the shade reference point Ps of the shade unit 43 is located on the lamp unit axis Ar. The shade unit 43 is inclined with respect to both the shade attachment piece units 44 such that the upper part of the shade unit 43 in the up-down direction is displaced forward in the axial direction, and is continuous with both the shade attachment piece units 44. Therefore, when the shade 24 is attached to both the attachment arm units 32 of the installation base unit 21, the shade reference axis a2 of the shade unit 43 is inclined with respect to the installation base unit reference axis a1. The inclination of the shade unit 43 will be described later.

The shade unit 43 is provided with a plurality of slit units 46 formed by partially cutting through a plate-like member. Each of the slit units 46 allows partial passage of light from each of the light sources (34, 35) that has been converged by the converging lens 23 (the converging lens body 41 of the converging lens 23) to form the projected illumination pattern Pi into a predetermined shape. Each of the slit units 46 in the first example is formed correspondingly to the illumination pattern Pi, and three slit units 46 are provided in the first example.

Each of the three slit units 46 corresponds to one of the three illumination figures Di. The projection lens 25 projects, onto the road surface 2, inverted image of the opening shape of each of the slit units 46 provided in the shade 24. Thus, the positional relationship of the slit units 46 is rotationally symmetrical around a projection lens optical axis Al described later with respect to the positional relationship of the illumination figures Di of the illumination pattern Pi. Therefore, for each of the slit units 46, the first slit unit 461 at the bottom in the up-down direction corresponds to the first illumination figure Di1 of the illumination pattern Pi, the second slit unit 462 above the first slit unit 461 corresponds to the second illumination figure Di2, and the third slit unit 463 above the second slit unit 462 corresponds to the third illumination figure Di3.

The position and size of each of the slit units 46 on the shade unit 43 are set such that each of the illumination figures Di has a desired size and a desired positional relationship on the road surface 2. As illustrated in FIG. 7, in the shade 24 of the first example, the three slit units 46 are arranged in the up-down direction and located above the lamp unit axis Ar. In the shade 24, the first slit unit 461 is located closest to the lamp unit axis Ar, the second slit unit 462 is located above the first slit unit 461, and the third slit unit 463 is located above the second slit unit 462. The first slit unit 461 and the second slit unit 462 correspond to the first light source 34, and the third slit unit 463 corresponds to the second light source 35. A center position C1 of the first slit unit 461 and the second slit unit 462 is located below the first light source 34 (a center position C2 of the first light source 34) in the up-down direction. The center position C1 of the first slit unit 461 and the second slit unit 462 is the center position in the up-down direction of the area in which the first slit unit 461 and the second slit unit 462 are provided, and is near the lower edge of the first light source 34 in the first example. Further, a center position C3 of the third slit unit 463 is located below a center position C4 of the second light source 35 in the up-down direction. Therefore, in terms of the center positions (C1 to C4), each of the slit units 46 is located below the corresponding light source (34, 35). The light that has passed through the shade 24 (each of the slit units 46) is projected onto the road surface 2 by the projection lens 25.

Each of the slit units 46 has a substantially trapezoidal shape. The size, shape, and interval of the three slit units 46 are set according to the distance to the road surface 2 such that the illumination figures Di on the road surface 2 are rectangles each having the size illustrated in FIG. 1 described above and arranged at even intervals. In other words, in the lamp unit 20, each of the slit units 46 has a different optical distance from itself through the projection lens 25 to the road surface 2, and thus, when projected onto the road surface 2 by the projection lens 25, each of the slit units 46 (each of the illumination figures Di, which is the light that has passed through the slit unit 46) has a size and interval according to the distance. In the first example, the first slit unit 461 is the smallest substantially trapezoidal shape, the second slit unit 462 is a substantially trapezoidal shape larger than the first slit unit 461, and the third slit unit 463 is a substantially trapezoidal shape larger than the second slit unit 462. In addition, each of the slit units 46 is wider in the width direction than the corresponding illumination figure Di, in terms of the relative size and shape ratio of the three. In addition, for each of the slit units 46, the interval between the second slit unit 462 and the third slit unit 463 is longer than the interval between the first slit unit 461 and the second slit unit 462.

In this way, the three slit units 46 are each different in size and shape from the corresponding illumination figure Di in terms of relative ratio, and are spaced at different intervals. Of the slit units 46, the first slit unit 461 is the smallest, and forms the first illumination figure Di1 magnified at the largest magnification ratio when the light that has passed through the first slit unit 461 is projected onto the road surface 2. Of the slit units 46, the third slit unit 463 is the largest, and forms the third illumination figure Di3 magnified at the smallest magnification ratio when the light that has passed through the third slit unit 463 is projected onto the road surface 2.

As illustrated in FIGS. 2 to 5, the projection lens 25 includes a projection lens body 47 that projects light that has passed through the shade 24, and a pair of projection lens attachment piece units 48 extending from the projection lens body 47 in the width direction. The projection lens body 47 is a convex lens having a circular shape when viewed in the axial direction, and in the first example, the incident surface and the exit surface are convex free-form surfaces. In the projection lens body 47, the projection lens optical axis Al is inclined with respect to the road surface 2, that is, with respect to the lamp unit axis Ar. This inclination will be described later. The projection lens body 47 projects each of the slit units 46 of the shade 24 to form the illumination pattern Pi on the road surface 2 (see FIG. 1). The incident surface and the exit surface may be either convex or concave as long as the projection lens body 47 is a convex lens, and are not limited to the configuration of the first example.

Both the projection lens attachment piece units 48 are plate-shaped and can be brought into contact with the respective shade attachment piece units 44 of the shade 24 attached to the end units of both the attachment arm units 32 of the installation base unit 21. Each of the projection lens attachment piece units 48 is provided with a projection lens positioning hole 48a and a projection lens screw through hole 48b. When the projection lens attachment piece units 48 are in contact with the shade attachment piece units 44, the positioning protrusions 32a can be fitted into the respective projection lens positioning holes 48a. When the projection lens attachment piece units 48 are in contact with the shade attachment piece units 44, the screws 33 to be inserted through the shade screw through holes 44b can be passed through the respective projection lens screw through holes 48b. The projection lens 25 is attached to both the attachment arm units 32 (end units thereof) of the installation base unit 21 by inserting the positioning protrusions 32a through the respective projection lens positioning holes 48a, and screwing each of the screws 33 inserted through the corresponding projection lens screw through hole 48b, into the corresponding screw hole 32b. In this projection lens 25, the projection lens optical axis Al is inclined at a predetermined angle with respect to the lamp unit axis Ar by setting the angle of the projection lens body 47 relative to both the projection lens attachment piece units 48.

Next, the configuration of the converging lens body 41 of the converging lens 23 will be described mainly with reference to FIGS. 5, 8, and 9. The converging lens body 41 includes the first lens unit 51 corresponding to the first light source 34 and the second lens unit 52 corresponding to the second light source 35. In the converging lens body 41 of the first example, the first lens unit 51 and the second lens unit 52 are integrally formed, and the second lens unit 52 is stacked on the first lens unit 51. In the converging lens 23 of the first example, the shapes, i.e., the optical settings, of the first lens unit 51 and the second lens unit 52 are determined such that each of the slit units 46 of the shade 24 is appropriately illuminated by light emitted from the light source unit 22, i.e., each of the light sources (34, 35).

The first lens unit 51 faces the first light source 34 (is located on the emission optical axis of the first light source 34) in the direction in which the installation base unit reference axis a1 extends (hereinafter also referred to as a direction of the installation base unit reference axis a1). The first lens unit 51 converges the light from the first light source 34, on an area of the shade 24 where the first slit unit 461 and the second slit unit 462 are provided. In the first lens unit 51, the central part of the incident surface on the lens side facing the first light source 34 is recessed toward the opposite side to the light source unit 22. The first lens unit 51 has the facing incident surface 53 curved convexly toward the light source unit 22 and provided at the center, the inclined incident surface 54 surrounding the facing incident surface 53, and the reflecting surface 55 having a truncated cone shape and surrounding the inclined incident surface 54.

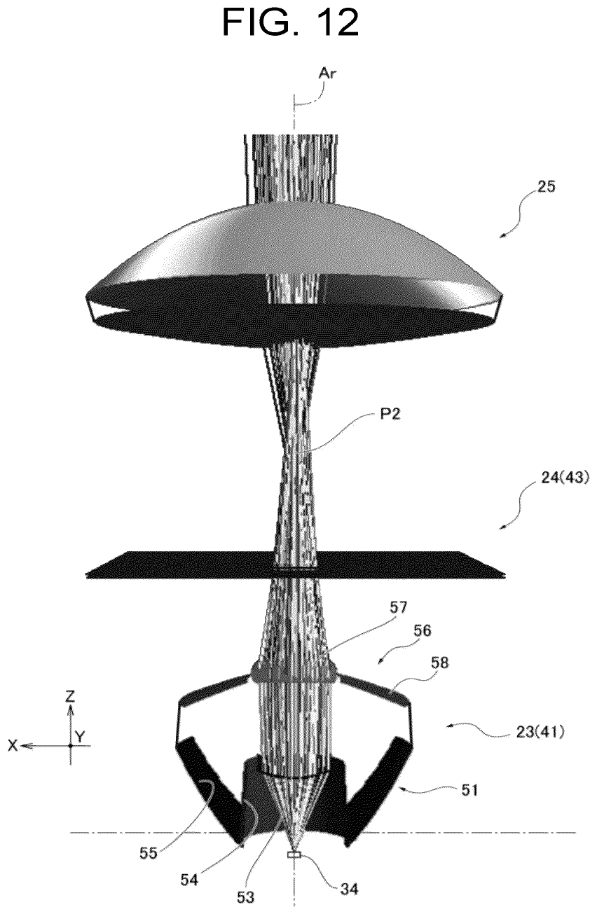

The facing incident surface 53 faces the first light source 34 in the direction of the installation base unit reference axis a1 and provided on the emission optical axis of the first light source 34, and the first light source 34 is located at or near a focal point on the rear side (rear focal point). The facing incident surface 53 causes the light from the first light source 34 to enter the first lens unit 51 as parallel light traveling approximately parallelly to the axis of the first lens unit 51, and to travel toward the inner exit surface unit 57 described later (see FIG. 12). The parallel light (parallel light beam) refers to collimated light created by causing light to pass through the facing incident surface 53.

The inclined incident surface 54 protrudes towards the first light source 34, and causes a part of light from the first light source 34 that does not travel toward the facing incident surface 53, to enter the first lens unit 51. The reflecting surface 55 is provided at a position reached by the light that has entered the converging lens 23 through the inclined incident surface 54 (see FIG. 10). The reflecting surface 55 reflects the light incident from the inclined incident surface 54 and causes the light to travel, as parallel light traveling approximately parallelly to the axis of the first lens unit 51, toward the outer exit surface unit 58 described later (see FIG. 10). The reflecting surface 55 may reflect light by utilizing total reflection, or may reflect light by aluminum, silver, or the like adhered by vapor deposition, coating, or the like.

In the first lens unit 51, a first exit surface 56 is provided to face the area of the shade 24 in which the first slit unit 461 and the second slit unit 462 are provided, and to converge light from the first light source 34, on the area of the shade 24 in which the first slit unit 461 and the second slit unit 462 are provided. In the first lens unit 51, light passed through the facing incident surface 53 is converted to direct light that travels directly toward the first exit surface 56, while light passed through the inclined incident surface 54 and reflected by the reflecting surface 55 is converted to reflection light reflected internally and then traveling toward the first exit surface 56. Since the first lens unit 51 has such a configuration, the light emitted from the corresponding first light source 34 can be efficiently utilized.

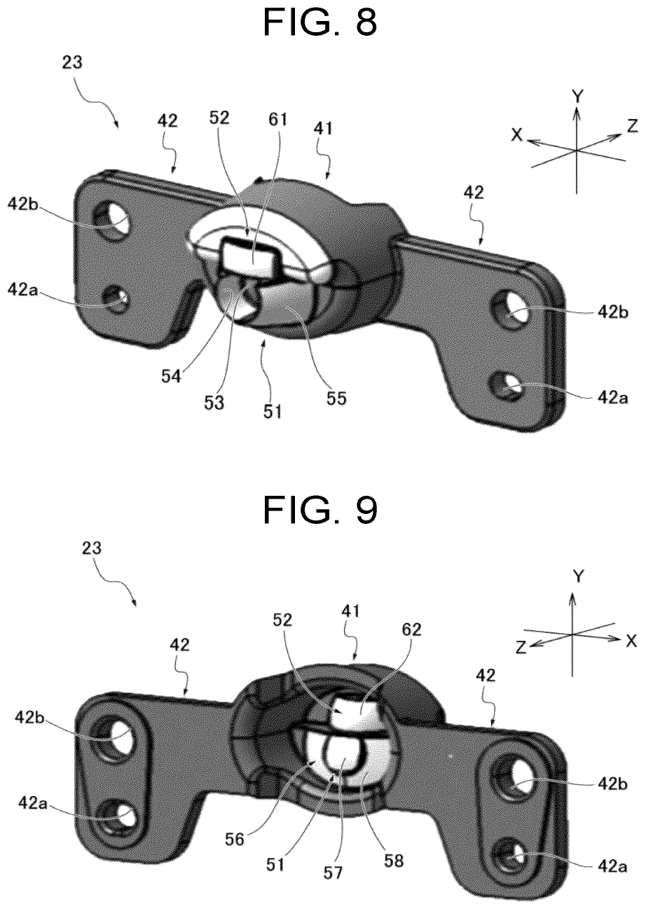

As illustrated in FIG. 9 and the like, when viewed from the front, the first exit surface 56 has a shape obtained by removing from a circular shape an upper part thereof, and has the inner exit surface unit 57 and the outer exit surface unit 58 which have different optical settings. The inner exit surface unit 57 is provided in an area of the first exit surface 56 reached by the light that has passed through the facing incident surface 53 (see FIG. 12), and has a substantially circular shape when viewed from the front. The inner exit surface unit 57 protrudes more toward the projection lens 25 side (front side in a front-rear direction) than the outer exit surface unit 58. The inner exit surface unit 57 refracts light from the first light source 34 that has passed through the facing incident surface 53, thereby forming a plurality of light distribution images of the first light source 34, on the first slit unit 461 and the second slit unit 462 of the shade 24. These light distribution images are formed to appropriately overlap with each other at positions according to the optical characteristics of the facing incident surface 53 and the inner exit surface unit 57. The optical characteristics can be set by adjusting the curvature (surface shape) of the facing incident surface 53 and the inner exit surface unit 57 for each location, and in the first example, the optical characteristics are set by gradually changing the curvature.

The outer exit surface unit 58 is provided to surround the areas on both sides of the inner exit surface unit 57 in the width direction and the area below the inner exit surface unit 57, and is located in the area reached by light that has been emitted by the first light source 34, passed through the inclined incident surface 54, and been reflected by the reflecting surface 55 (see FIG. 10). The outer exit surface unit 58 is located rearward of the inner exit surface unit 57 in the front-rear direction. The outer exit surface unit 58 refracts light that has emitted from the first light source 34, passed through the inclined incident surface 54, and reflected by the reflecting surface 55, to form a plurality of light distribution images of the first light source 34, on the first slit unit 461 and the second slit unit 462 of the shade 24. These light distribution images are formed to appropriately overlap with each other at positions according to the optical characteristics of the reflecting surface 55 and the outer exit surface unit 58. The optical characteristics can be set by adjusting the curvature (surface shape) of the outer exit surface unit 58 and the reflecting surface 55 for each location, and in the first example, the optical characteristics are set by gradually changing the curvature.

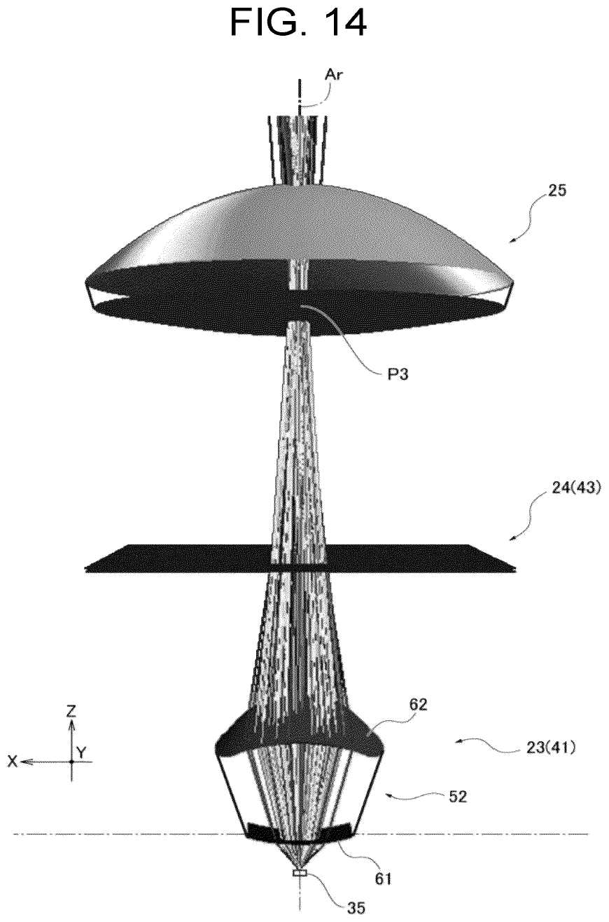

The second lens unit 52 is a convex lens having a substantially rectangular shape elongated in the width direction when viewed from the front in the direction of the installation base unit reference axis a1, and as a whole, converges spread light that has emitted from the second light source 35, on the area where the third slit unit 463 of the shade 24 is provided (see FIG. 14). The second lens unit 52 has a second incident surface 61 facing the second light source 35 and a second exit surface 62 facing away from the second light source 35. In the second lens unit 52 of the first example, each of the second incident surface 61 and the second exit surface 62 is a convex free-form surface. Note that the second incident surface 61 and the second exit surface 62 may be convex or concave as long as the second lens unit 52 is a convex lens, and are not limited to the configuration of the first example.

The second incident surface 61 faces the second light source 35 in the direction of the installation base unit reference axis a1, and the second light source 35 is located at or near a focal point on the rear side (rear focal point). The second incident surface 61 causes the light from the second light source 35 to enter the second lens unit 52 as parallel light traveling approximately parallelly to the axis of the second lens unit 52 (see FIG. 14). The second exit surface 62 is provided on the opposite side to the second incident surface 61, and refracts the light that has passed through the second incident surface 61, thereby converging the light and causing the light to travel forward in the front-to-rear direction. The second exit surface 62 provides the light that has been emitted by the second light source 35 and passed through the second incident surface 61 to form, on the shade 24 (shade unit 43), a plurality of light distribution images of the second light source 35. These light distribution images are formed to appropriately overlap with each other at positions according to the optical characteristics of the second incident surface 61 and the second exit surface 62. The optical characteristics can be set by adjusting the curvature (surface shape) of the second incident surface 61 and the second exit surface 62 for each location, and in the first example, the optical characteristics are set by gradually changing the curvature.

Next, the postures of the installation base unit 21, the light source unit 22, the converging lens 23, the shade 24, and the projection lens 25 relative to the lamp unit axis Ar in the vehicle lamp 10 will be described. First, in the projection lens 25 (projection lens body 47), as illustrated in FIG. 5, the reference focal point Fb is set on the lamp unit axis Ar and at or near the shade 24. In the first example, the reference focal point Fb coincides with the shade reference point Ps of the shade 24. Here, in the projection lens 25 (projection lens body 47), the incident surface and the exit surface are free-form surfaces based on a basic curved surface. Assuming the incident surface and the exit surface in the projection lens 25 are in the forms of their basic curved surfaces, the projection lens optical axis Al can be defined as a center line of the basic curved surfaces. Assuming the incident surface and the exit surface are in the forms of their basic curved surfaces, and if light parallel to the projection lens optical axis Al of the projection lens 25 (projection lens body 47) is incident on the exit surface, the light converges on the reference focal point Fb. Note that the projection lens 25 has free-form surfaces as the incident surface and exit surface as described above, and thus a part of luminous flux of such a parallel light incident on the exit surface may not pass through the reference focal point Fb. This reference focal point Fb coincides with the shade reference point Ps on the shade 24, and is therefore located between the shade 24 and the projection lens 25. The reference focal point Fb can be set appropriately as long as the reference focal point Fb is located between the shade 24 and the projection lens 25. Here, the phrase “between the shade 24 and the projection lens 25” is not limited to the space between the shade 24 and the projection lens 25, but also includes positions overlapping with the shade 24 or the projection lens 25.

The projection lens 25 is arranged in a position rotated (inclined) about a line passing through the reference focal point Fb and extending in the width direction, to have a front part in the axial direction of the projection lens optical axis Al located below the lamp unit axis Ar. The downward angle of the projection lens optical axis Al relative to the lamp unit axis Ar is defined as a first inclination angle 01. In the first example, the first inclination angle 01 is set to 20 degrees. Note that, the magnitude of the first inclination angle θ1 is not limited to that of the configuration of the first example, as long as the projection lens 25 is arranged to have a front part in the axial direction of the projection lens optical axis Al, rotated about the reference focal point Fb set at the above-described position, downward with respective to the lamp unit axis Ar. The first inclination angle θ1 is preferably in the range from 15 degrees to 20 degrees. The first inclination angle θ1 is set according to the position where the illumination pattern Pi is formed on the road surface 2 in the surrounding area behind the vehicle 1, and in the first example is set to 20 degrees to form the illumination pattern Pi in an area within 3 m from the vehicle 1. In other words, the projection lens 25 inclined at the first inclination angle θ1 allows the lamp unit 20 of the first example to form the illumination pattern Pi in an area within 3 m from the vehicle 1.

In addition, the shade 24 is arranged such that the front side in the axial direction of the shade reference axis a2 is rotated (inclined) about a line passing through the reference focal point Fb of the projection lens 25, i.e., the shade reference point Ps set on the shade 24 and extending in the width direction, downward with respect to the lamp unit axis Ar. In the shade 24, the angle of the shade reference axis a2 relative to the lamp unit axis Ar is equal to the angle of the projection lens 25 (projection lens optical axis Al) relative to the lamp unit axis Ar (first inclination angle θ1). Therefore, in the shade 24 of the first example, the shade reference axis a2 is inclined downward at 20 degrees with respect to the lamp unit axis Ar, and the shade reference axis a2 coincides with the projection lens optical axis Al. Note that the shade 24 is not limited to the configuration of the first example, as long as the shade 24 is arranged such that the front side in the axial direction of the shade reference axis a2 is rotated about the reference focal point Fb set at the above-described position, at an angle (first inclination angle θ1) equal to that of the projection lens 25 (projection lens optical axis Al), downward with respect to the lamp unit axis Ar.

When both the projection lens attachment piece units 48 and both the shade attachment piece units 44 are attached to both the attachment arm units 32 (end units thereof) of the installation base unit 21, the projection lens optical axis Al of the projection lens 25 coincides with the shade reference axis a2 of the shade 24. The projection lens 25 and the shade 24 are arranged such that the front side in the axial direction of the projection lens optical axis Al and the shade reference axis a2 is rotated downward about the reference focal point Fb at the first inclination angle θ1 (20 degrees) with respect to the lamp unit axis Ar. Therefore, the projection lens 25 and the shade 24 are inclined downward with respect to the lamp unit axis Ar in a state where the projection lens 25 and the shade 24 face each other in the direction in which the projection lens optical axis Al (shade reference axis a2) extends. The projection lens 25 has the reference focal point Fb that is on the lamp unit axis Ar and coincides with the shade reference point Ps of the shade 24, and thus can form an image of each of the slit units 46 of the shade unit 43, on the projection lens optical axis Al with the least aberration according to the optical settings of the projection lens 25. Therefore, the projection lens 25 can project the light that has passed through each of the slit units 46 of the shade 24 to which a luminous flux distribution described below is applied, the vicinity of a position on the road surface 2 that intersects with the projection lens optical axis Al.

Here, since the projection lens 25 is arranged at a position rotated downward with respect to the lamp unit axis Ar as described above, if the projection lens 25 has a circular shape when viewed in the direction of the projection lens optical axis Al, the projection lens 25 would protrude downward in the up-down direction further than the other members of the lamp unit 20 (the installation base unit 21, the light source unit 22, the converging lens 23, and the shade 24). To prevent such protrusion, the lower edge of the projection lens 25 in the up-down direction is cut out to form a lower edge surface 25a. The lower edge surface 25a is formed by partially cutting out a part of the projection lens 25 that protrudes downward further than other members, and in the first example, is a flat surface that is located above the lower edge of the installation base unit 21 in the up-down direction. As a result, despite being inclined at the first inclination angle θ1 with respect to the lamp unit axis Ar, the projection lens 25 does not protrude further downward than the other members of the lamp unit 20, and an increase in the dimension of the lamp unit 20 in the up-down direction can be prevented.

Next, in the base unit 31, as described above, the installation base unit reference point Ph is set at or near the substrate 36 of the light source unit 22, and the installation base unit reference axis a1 passing through the installation base unit reference point Ph and being perpendicular to the substrate 36 (the light source attachment location) is set. The base unit 31 is arranged in a position rotated (inclined) about a line passing through the installation base unit reference point Ph and extending in the width direction, such that the front side in the axial direction of the installation base unit reference axis a1 is located below the lamp unit axis Ar. The downward angle of the installation base unit reference axis a1 with respect to the lamp unit axis Ar is defined as a second inclination angle 02. In the first example, the second inclination angle θ2 is set to 10 degrees. The base unit 31 may be arranged in a position rotated downward with respect to the lamp unit axis Ar, about the installation base unit reference point Ph, which is set above the lamp unit axis Ar in the up-down direction and at or near the light source unit 22 (the substrate 36 of the light source unit 22). In other words, the second inclination angle θ2 can be set to any suitable value as long as the angle results in rotation of the base unit 31 as described above, and is not limited to the configuration of the first example. The second inclination angle θ2 is set to be equal to or less than the first inclination angle θ1, and is preferably set to be approximately half the first inclination angle θ1. When the base unit 31 is attached to the vehicle lamp 10 using the attachment rib 31d, the installation base unit reference axis a1 is inclined downward at 10 degrees with respect to the lamp unit axis Ar, as described above.

The converging lens 23 is arranged in a position rotated (inclined) about a line passing through the installation base unit reference point Ph of the base unit 31 and extending in the width direction, at an angle equal to the angle of the base unit 31 (the installation base unit reference axis a1) (second inclination angle θ2), downward with respect to the lamp unit axis Ar. For this reason, the converging lens 23 of the first example is inclined in the same way as the base unit 31 such that the first lens unit 51 faces the first light source 34 in the direction of the installation base unit reference axis a1 and the second lens unit 52 faces the second light source 35 in the direction of the installation base unit reference axis a1. Note that the converging lens 23 is not limited to the configuration of the first example as long as the converging lens 23 is rotated about the installation base unit reference point Ph, downward with respect to the lamp unit axis Ar together with the base unit 31, in a state where the positional relationship between the converging lens 23 and the base unit 31 (each of the light sources (34, 35)) is set. Once both the converging lens attachment piece units 42 are attached to both the attachment arm units 32 (end units thereof) of the installation base unit 21, the converging lens 23 is in a state of being rotated downward with respect to the lamp unit axis Ar together with the base 31 as described above.

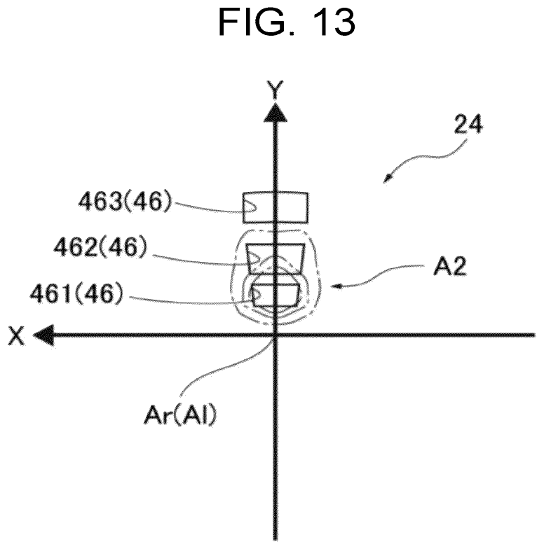

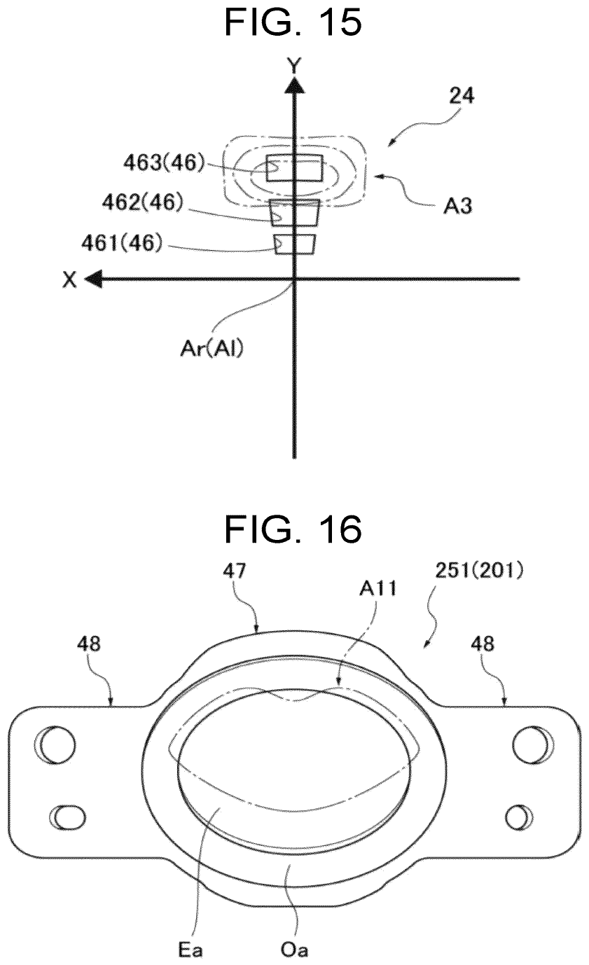

Next, the optical settings of the converging lens 23 will be described with reference to FIGS. 10 to 15. The first lens unit 51 of the converging lens 23 provides light from the outer exit surface unit 58 to form a first illumination area Al (see FIG. 11), and light from the inner exit surface unit 57 to form a second illumination area A2 (see FIG. 13). In addition, the second lens unit 52 of the converging lens 23 provides light to form a third illumination area A3 (see FIG. 15). This will be described below.

First, in the first lens unit 51, the outer exit surface unit 58 is configured to converge light that has been emitted from the first light source 34, passed through the inclined incident surface 54, and reflected by the reflecting surface 55, on a first position P1 slightly beyond the shade 24, at least in the cross section (horizontal section) as illustrated in FIG. 10. The first position P1 is set such that light is prevented from traveling to the peripheral unit of the projection lens 25 (the projection lens body 47 thereof). In addition, the first position Pl is set near the shade 24 to allow light from the outer exit surface unit 58, which is large relative to the first slit unit 461 and the second slit unit 462, to converge at the first slit unit 461 and the second slit unit 462. The first lens unit 51 provides, from the outer exit surface unit 58 onto the shade 24, the light that has been emitted from the first light source 34, passed through the inclined incident surface 54, and reflected by the reflecting surface 55, to form the second illumination area Al illustrated in FIG. 11. The first illumination area Al illuminates the entire first slit unit 461 and the entire second slit unit 462 and has a high luminous flux density, and in particular, the luminous flux density is higher in approximately the upper half of the first slit unit 461 and approximately the lower half of the second slit unit 462.

In addition, in the first lens unit 51, the inner exit surface unit 57 is configured to converge light that has been emitted from the first light source 34 and passed through the facing incident surface 53, on a second position P2 beyond the shade 24, at least in the cross section (horizontal section) as illustrated in FIG. 12. The second position P2 is set such that light is prevented from traveling to the peripheral unit of the projection lens 25 (the projection lens body 47 thereof). The second position P2 is away from the shade 24 compared to the first position P1, that is, a position located closer to the projection lens 25 than the first position P1. The second position P2 is set between the shade 24 and the projection lens 25 to allow light from the inner exit surface unit 57 to converge at the first slit unit 461 and the second slit unit 462. The first lens unit 51 provides, from the inner exit surface unit 57 onto the shade 24, the light that has been emitted from the first light source 34 and passed through the facing incident surface 53, to form the second illumination area A2 illustrated in FIG. 13. The second illumination area A2 illuminates the entire first slit unit 461 with the highest luminous flux density, and also illuminates the entire second slit unit 462.

Therefore, the first lens unit 51 provides the light from the first light source 34 to form the first illumination area Al and the second illumination area A2 on the shade 24 in an overlapping manner. As a result, the first lens unit 51 can illuminate the entire first slit unit 461 and the entire second slit unit 462 such that the highest luminous flux density is applied to the first slit unit 461 and the second highest luminous flux density is applied to the second slit unit 462. Note that distribution and shape, etc. of brightness in the illumination areas formed by the inner exit surface unit 57 and the outer exit surface unit 58 may be appropriately set and are not limited to those in the first example, as long as the first lens unit 51 forms an illumination area that illuminates the first slit unit 461 and the second slit unit 462 for appropriately forming the corresponding first illumination figure Di1 and second illumination figure Di2.

In addition, in the second lens unit 52, the second exit surface 62 is configured to converge light that has been emitted from the second light source 35 and passed through the second incident surface 61, on a third position P3 that is significantly beyond the shade 24, at least in the cross section (horizontal section) as illustrated in FIG. 14. The third position P3 is set such that light is prevented from traveling to the peripheral unit of the projection lens 25 (the projection lens body 47 thereof). The third slit unit 463 corresponds to the third illumination figure Di3 and, the third illumination figure Di3 is formed at the closest position among the illumination figures Di. Thus, to avoid excessive convergence of light from the second exit surface 62 at the third slit unit 463, the third position P3 is a position farther from the shade 24 than the second position P2, i.e., a position closer to the projection lens 25 than the second position P2. The second lens unit 52 provides, from the second exit surface 62 onto the shade 24, the light that has been emitted from the second light source 35 and passed through the second incident surface 61, to form the third illumination area A3 illustrated in FIG. 15. The third illumination area A3 illuminates the entire third slit unit 463, and a higher luminous flux density is applied to the lower half of the third slit unit 463. The third illumination area A3 has a lower luminous flux density as a whole, compared to the illumination of the first slit unit 461 and the second slit unit 462 by the first lens unit 51.

The converging lens 23 provides light from the first light source 34 through the first lens unit 51 to illuminate the entire first slit unit 461 and the entire second slit unit 462, provides light from the second light source 35 through the second lens unit 52 to illuminate the entire third slit unit 463. The converging lens 23 provides the highest luminous flux density to the first slit unit 461, the second highest luminous flux density to the second slit unit 462, and the third highest luminous flux density to the third slit unit 463. As a result, the converging lens 23 can appropriately illuminate the first slit unit 461, the second slit unit 462, and the third slit unit 463 on the shade 24.

Next, the operation of the vehicle lamp 10 will be described. In the lamp unit 20 of the vehicle lamp 10, power is supplied from the lighting control circuit to each of the light sources (34, 35) via the substrate 36, thereby turning the light sources on and off. The light from each of the light sources (34, 35) is converged by the converging lens 23 and illuminates the shade 24, passes through each of the slit units 46 of the shade 24, and then is projected by the projection lens 25 to form the illumination pattern Pi on the road surface 2. The illumination pattern Pi is formed simultaneously at a position where three illumination figures Di are arranged in a straight line by projecting, by the projection lens 25, the light that has passed through each of the slit units 46 of the shade 24 to which the above-mentioned illumination (luminous flux) distribution is applied, i.e., the state of each of the slit units 46 being illuminated by the light from each of the light sources (34, 35).

In the vehicle lamp 10, the lamp unit 20 operates in conjunction with a back lamp, and thus when the back lamp is turned on, the light sources (34, 35) on the left and right sides are turned on and form the illumination pattern Pi on the road surface 2. Therefore, when the vehicle 1 is about to back up, the vehicle lamp 10 can display the illumination pattern Pi formed on the road surface 2, to traffic participants such as other vehicles and pedestrians. In addition, the vehicle lamp 10 can assist the driver of the vehicle 1 in driving by allowing the driver to see the illumination pattern Pi as the direction in which the driver is actually backing up the vehicle 1 during backing operation.

Here, the conventional vehicle lamps described in the prior art documents includes a lamp unit, which is a combination of a light source, a light blocking member, and a projection lens and which is inclined downward to form an illumination pattern on the road surface. For such vehicle lamps, it is required to form an illumination pattern in the vicinity of the driver's vehicle (the vehicle in which the vehicle lamp is installed), so it is conceivable to increase the degree of inclining of the lamp unit in response to this requirement. However, a vehicle lamp is commonly installed in a vehicle such that a lamp unit and the like are arranged along a vehicle axis set on the vehicle, and a dimension of the vehicle lamp in an up-down direction perpendicular to the vehicle axis is desired to be reduced. In addition, in vehicle lamps, for example, another lamp may be provided in the same lamp chamber as the lamp unit. However, due to the limited size of the lamp chamber, a lamp unit inclined significantly may interfere with the other lamp. For these reasons, conventional vehicle lamps have limitations in terms of forming the illumination pattern by the lamp unit near the driver's vehicle without increasing the dimension in the up-down direction.

In contrast, in the lamp unit 20 of the vehicle lamp 10, the reference focal point Fb of the projection lens 25 is located on the lamp unit axis Ar and at or near the shade reference point Ps of the shade 24, the projection lens 25 and the shade 24 are rotated about the reference focal point Fb, and the projection lens optical axis Al and the shade reference axis a2 are inclined downward with respect to the lamp unit axis Ar.

Therefore, in the lamp unit 20, light emitted from each of the light sources (34, 35) can pass through each of the slit units 46 in the shade 24 (the shade unit 43 thereof), and the projection lens 25 can project the light onto the projection lens optical axis Al. Here, in the lamp unit 20, each of the slit units 46 provided near the shade reference point Ps can be positioned in or near the focal plane of the projection lens 25, because the reference focal point Fb is located at or near the shade reference point Ps of the shade 24 and the shade 24 is arranged to be perpendicular to the projection lens optical axis Al.

Therefore, the projection lens 25 of the lamp unit 20 can project an image of each of the slit units 46 being illuminated, onto the projection lens optical axis Al, with the least aberration according to the optical settings. As a result, even if the lamp unit axis Ar of the lamp unit 20 is set parallelly to the road surface 2, the lamp unit 20 can be positioned above the road surface 2 and appropriately form the illumination pattern Pi in the vicinity of the vehicle 1 on the road surface 2.

In addition, in the lamp unit 20, the installation base unit reference point Ph is set above the lamp unit axis Ar and at or near the substrate 36, and the base unit 31 and the converging lens 23 are inclined downward with respect to the lamp unit axis Ar by being rotated about the installation base unit reference point Ph. Therefore, in the lamp unit 20, the converging lens 23 can converge light from each of the light sources (34, 35) onto each of the slit units 46 of the shade 24, and then the light that has passed through each of the slit units 46 can be appropriately directed to the projection lens 25. This will be described with reference to FIGS. 16 to 19. In FIGS. 16 to 19, the central area of a projection lens 251 of a first comparative example or the projection lens 25 of the first example in which the optical design is strongly reflected is denoted as an effective area Ea, and an area surrounding the effective area Ea is denoted as an outer rim area Oa.

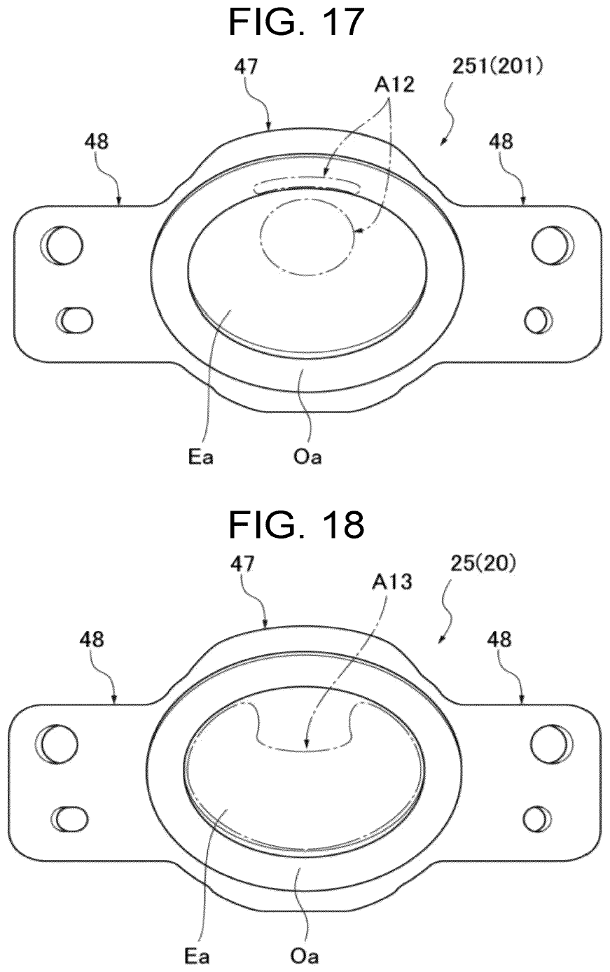

FIGS. 16 and 17 illustrate the distribution on the projection lens 251 of light from each light source in a lamp unit 201 of the first comparative example. The lamp unit 201 of the first comparative example has a basic configuration similar to that of the lamp unit 20, but differs from the lamp unit 20 in that the base unit and the converging lens are not rotated about the installation base unit reference point. That is, the lamp unit of the first comparative example has a configuration in which only the projection lens 251 and the shade are rotated downward about the reference focal point. That is, in the lamp unit 201 of the first comparative example, the projection lens 251 and the shade are inclined at a first inclination angle θ1 to form an illumination pattern in the vicinity of the vehicle, but the base unit and the converging lens are not inclined downward. As illustrated in FIG. 16, in the lamp unit 201 of the first comparative example, the light that has been emitted from the first light source (34) and converged by the first lens unit (51) forms a distribution area A11 on the projection lens 251. The distribution area A11 is unevenly located at the upper part of the effective area Ea, and the upper part of distribution area A11 protrudes into the outer rim area Oa. Furthermore, as illustrated in FIG. 17, in the lamp unit 201 of the first comparative example, the light that has been emitted from the second light source (35) and converged by the second lens unit (52) forms a distribution area A12 on the projection lens 251. This distribution area A12 is unevenly located at the upper part of the effective area Ea, and the upper part of distribution area A12 is located in the outer rim area Oa.

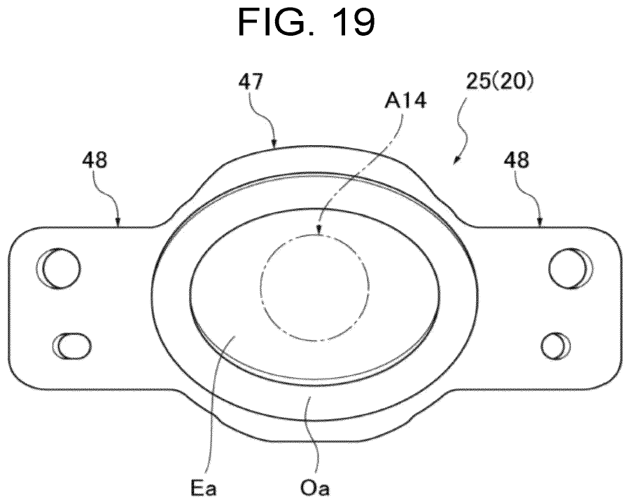

In contrast, in the lamp unit 20 of the first example, as illustrated in FIG. 18, the light that has been emitted from the first light source 34 and converged by the first lens unit 51 forms a distribution area A13 on the projection lens 25. The entire distribution area A13 is within the effective area Ea. Furthermore, in the lamp unit 20 of the first example, as illustrated in FIG. 19, the light that has been emitted from the second light source 35 and converged by the second lens unit 52 forms a distribution area A14 on the projection lens 25. The distribution area A14 is located at or near the center of the effective area Ea. Therefore, the lamp unit 20 of the first example can deliver the light from each of the light sources (34, 35) to the effective area Ea of the projection lens 25, because the installation base unit 21 and the converging lens 23 are inclined downward with respect to the lamp unit axis Ar by being rotated about the installation base unit reference point Ph.

As described above, even when the projection lens 25 and the shade 24 are inclined downward at the first inclination angle θ1, the lamp unit 20 of the first example can deliver the light from each of the light sources (34, 35) to the effective area Ea of the projection lens 25 (see areas surrounded by dashed lines in FIGS. 18, 19, and 5), because the installation base unit 21 and the converging lens 23 are inclined downward. In other words, in the lamp unit 20, the projection lens 25 and the shade 24 inclined downward allow the illumination pattern Pi to be properly formed at a position close to the vehicle 1 on the road surface 2, and the installation base unit 21 and the converging lens 23 inclined downward allow the light from each of the light sources (34, 35) to be properly guided to the projection lens 25. As a result, in the lamp unit 20, the projection lens 25 can efficiently converge the light from each of the light sources (34, 35) according to the optical settings, the image of each of the slit units 46 being illuminated can be properly projected onto the projection lens optical axis Al, and the illumination pattern Pi can be properly formed at a position close to the vehicle 1 on the road surface 2.

In addition, in the lamp unit 20 of the first example, the reference focal point Fb, which is the center of rotation of the projection lens 25 and the shade 24, is located on the shade 24 and the installation base unit reference point Ph, which is the center of rotation of the installation base unit 21 and the converging lens 23, is located on the substrate 36. Furthermore, in the lamp unit 20, the lamp unit axis Ar extends along the horizontal direction, the projection lens 25 and shade 24 are rotated about the reference focal point Fb to be inclined downward at 20 degrees, and the installation base unit 21 and converging lens 23 are rotated about the installation base unit reference point Ph to be inclined downward at 10 degrees. Thus, in the lamp unit 20, the rotation center of the projection lens 25 and the shade 24 is at a different location from that of the installation base unit 21 and the converging lens 23, and each of these rotation centers is located between members that are rotated together. Therefore, the lamp unit 20 can reduce the amount of movement in the up-down direction of the projection lens 25 and shade 24, and the installation base unit 21 and converging lens 23, compared to a case where all of these members are inclined about a single rotation center. As a result, in the lamp unit 20, the projection lens 25 and the shade 24 can be inclined downward at 20 degrees, and the installation base unit 21 and the converging lens 23 can be inclined downward at 10 degrees, without increasing the height dimension. Therefore, the lamp unit 20 can appropriately form the illumination pattern Pi at a position close to the vehicle 1 on the road surface 2 as described above, without increasing the dimension in the up-down direction.

Furthermore, in the lamp unit 20 of the first example, the installation base unit reference point Ph, which is the rotation center of the base unit 31 and the converging lens 23, is located above the reference focal point Fb, which is the rotation center of the projection lens 25 and the shade 24. In addition, in the lamp unit 20, each of the light sources (34, 35) of the light source unit 22 provided on the installation base unit 21 and the converging lens 23 are located above the lamp unit axis Ar. Thus, in the lamp unit 20, the position of the rotation center can be closer to each of the light sources (34, 35) and the converging lens 23, compared to a case where the installation base unit reference point Ph is located below the lamp unit axis Ar, and thus the amount of movement of each of the light sources (34, 35) and the converging lens 23 caused by being rotated by the second inclination angle θ2 can be reduced. As a result, in the lamp unit 20, reduction of the distance from the converging lens 23 to the shade 24 which is also rotated, caused by the rotation about the installation base unit reference point Ph, can be prevented. Therefore, the lamp unit 20 can have a distance between the converging lens 23 and the shade 24 set appropriately for converging the light from each of the light sources (34, 35) using the converging lens 23 to form each illumination area A on the shade 24 as described above. This enables the lamp unit 20 to more appropriately form the illumination pattern Pi at a position on the road surface 2 close to the vehicle 1.

In the lamp unit 20 of the vehicle lamp 10, the two light sources (34, 35) are provided above the lamp unit axis Ar, and each of the slit units 46 is provided above the lamp unit axis Ar. Therefore, in the lamp unit 20, the direction of light emitted from each of the light sources (34, 35), passing through each of the slit units 46, and traveling toward the projection lens 25 can be inclined downward with respect to the lamp unit axis Ar, and the direction of light projected by the projection lens 25 can be inclined downward with respect to the lamp unit axis Ar. Therefore, in the lamp unit 20, the positional relationship of the light source unit 22 and the shade 24 with respect to the projection lens 25 can facilitate forming the illumination pattern Pi in the vicinity of the vehicle 1. As a result, the lamp unit 20 can more appropriately form the illumination pattern Pi in an area within 3 m from the vehicle 1 without inclining the entire lamp unit 20, i.e., the lamp unit axis Ar. In addition, in the lamp unit 20, the optical settings of the converging lens 23 can be simplified, because the positional relationship of the light source unit 22 and the shade 24 with respect to the projection lens 25 can facilitate forming the illumination pattern Pi in the vicinity of the vehicle 1.

In the lamp unit 20, the center position C1 of the first slit unit 461 and the second slit unit 462 is located below the center position C2 of the first light source 34, and the center position C3 of the third slit unit 463 is located below the center position C4 of the second light source 35. As a result, in the lamp unit 20, the direction of light traveling from each of the light sources (34, 35) to the corresponding slit unit 46 can be inclined downward with respect to the lamp unit axis Ar, and thus downward redirection effect using the positional relationship of the light source unit 22 and the shade 24 with respect to the projection lens 25 can be further enhanced. As a result, in the lamp unit 20, optical settings for the converging lens 23 can be reasonable, the downward inclination of the lamp unit axis Ar within the lamp chamber can be suppressed, and the lamp unit 20 can more appropriately form the illumination pattern Pi in an area within 3 m from the vehicle 1.

In the lamp unit 20, a convergence point (first position P1) of light reflected by the reflecting surface 55 and emitted from the outer exit surface unit 58, a convergence point (second position P2) of light passing through the facing incident surface 53 and emitted from the inner exit surface unit 57, and a convergence point (third position P3) of light passing through the second incident surface 61 and emitted from the second exit surface 62 are set in order from the shade 24 side. In this way, in the lamp unit 20, each of the above-mentioned convergence points is adapted to provide suitable density and distribution of the luminous flux at each of the slit units 46 on the shade 24, and thus the illumination pattern Pi can be appropriately formed with a simple configuration. In particular, in the lamp unit 20 of the first example, the above-mentioned convergence points are set to prevent light from traveling to the peripheral unit of the projection lens 25 (the projection lens body 47 thereof), and thus the projection lens 25 can project light with little aberration according to the optical settings, and appropriately form the illumination pattern Pi. This means that, in the lamp unit 20 in which each of the light sources (34, 35) is a white light source, occurrence of color fringes (formation of parallel bands with different colors) in the illumination pattern Pi can be suppressed.

The lamp unit 20 and the vehicle lamp 10 of the first example can provide the following effects.

The lamp unit 20 includes a plurality of light sources (34, 35), the converging lens 23 that converges light from the plurality of light sources (34, 35), the shade 24 provided with a plurality of slit units 46 that allows partial passage of the light that has been converged by the converging lens 23, and the projection lens 25 that projects the light that has passed through the shade 24, to form the illumination pattern Pi having a plurality of illumination figures Di corresponding to the plurality of slit units 46. In the lamp unit 20, the projection lens 25 has the reference focal point Fb set on the lamp unit axis Ar, the projection lens 25 and the light blocking member (shade) 24 are rotated downward about the reference focal point Fb, and the installation base unit 21 and the converging lens 23 are rotated downward about the installation base unit reference point Ph set behind and above the reference focal point Fb. Therefore, the lamp unit 20 can appropriately form the illumination pattern Pi at a position close to the vehicle 1 on the road surface 2, without increasing the height dimension in the up-down direction.

In the lamp unit 20, the first inclination angle θ1 of the projection lens 25 and the light blocking member (shade 24) relative to the lamp unit axis Ar is larger than the second inclination angle θ2 of the installation base unit 21 and the converging lens 23 relative to the lamp unit axis Ar. Therefore, in the lamp unit 20, the first inclination angle θ1 of the projection lens 25 and the light blocking member (shade 24) can be set to appropriately form the illumination pattern Pi at a position close to the vehicle 1 on the road surface 2, and light from each of the light sources (34, 35) can be delivered to an appropriate position on the projection lens 25.

In the lamp unit 20, the reference focal point Fb is provided between the projection lens 25 and the light blocking member (shade 24), and the installation base unit reference point Ph is provided between the installation base unit 21 and the converging lens 23. Therefore, the lamp unit 20 can more effectively reduce the amount of movement in the up-down direction of the projection lens 25 and the shade 24, and the installation base unit 21 and the converging lens 23, and more effectively suppress an increase in the height dimension in the up-down direction.

In the lamp unit 20, the second inclination angle θ2 is such that the light that has been converged by the converging lens 23 and passed through the light blocking member (shade 24) is guided to the effective area Ea of the projection lens 25. As a result, the lamp unit 20 can properly guide light from each of the light sources (34, 35) to the projection lens 25 inclined downward, and can more properly form the illumination pattern Pi at a position close to the vehicle 1 on the road surface 2.

In the lamp unit 20, the plurality of light sources (34, 35) are provided above the lamp unit axis Ar, and the plurality of slit units 46 are provided above the lamp unit axis Ar. Therefore, in the lamp unit 20, the direction of light emitted from each of the light sources (34, 35), passing through each of the slit units 46, and traveling toward the projection lens 25 can be inclined downward with respect to the lamp unit axis Ar, and the direction of light projected by the projection lens 25 can be inclined downward with respect to the lamp unit axis Ar. As a result, the lamp unit 20 can form the illumination pattern Pi in the vicinity of the vehicle 1 without inclining the lamp unit axis Ar downward, and the optical settings of the converging lens 23 can be simplified.

In the lamp unit 20, each of the light sources (34, 35) is provided correspondingly to at least one or more of the slit units 46, and each of the light sources (34, 35) is provided above a center position (C1, C3) of the corresponding at least one or more of the slit units 46. As a result, in the lamp unit 20, the direction of light traveling from each of the light sources (34, 35) to the corresponding slit unit 46 can be inclined downward with respect to the lamp unit axis Ar, and thus downward redirection effect using the positional relationship of the light source unit 22 and the shade 24 with respect to the projection lens 25 can be further enhanced.

In the lamp unit 20, the illumination figure Di includes the first illumination figure Di1, the second illumination figure Di2, and the third illumination figure Di3, the plurality of slit units 46 include the first slit unit 461 corresponding to the first illumination figure Di1, the second slit unit 462 corresponding to the second illumination figure Di2, and the third slit unit 463 corresponding to the third illumination figure Di3. The lamp unit 20 further includes, as light sources, the first light source 34 corresponding to the first slit unit 461 and the second slit unit 462, and the second light source 35 corresponding to the third slit unit 463. Therefore, in the lamp unit 20, the corresponding relationship between both the light sources (34, 35) and the slit units 46 can be clearly defined, and the optical settings of the converging lens 23 can be easily configured.

In the lamp unit 20, the center position C2 of the first light source 34 is located above the center position C1 of the area in which the first slit unit 461 and the second slit unit 462 are provided, and the center position C4 of the second light source 35 is located above the center position C3 of the third slit unit 463. As a result, in the lamp unit 20, the direction of light traveling from each of the light sources (34, 35) to the corresponding slit unit 46 can be inclined downward with respect to the lamp unit axis Ar, and the traveling direction of the light projected by the projection lens 25 can be more effectively inclined downward with respect to the lamp unit axis Ar.

In the lamp unit 20, the converging lens 23 has a configuration in which the first lens unit 51 corresponding to the first light source 34 and the second lens unit 52 corresponding to the second light source 35 are stacked. In the lamp unit 20, the first lens unit 51 has the facing incident surface 53 facing the first light source 34, the inclined incident surface 54 surrounding the facing incident surface 53, and the reflecting surface 55 surrounding the inclined incident surface 54, and the second lens unit 52 is a convex lens that converges light from the corresponding second light source 35. Therefore, the lamp unit 20 allows the light from the first light source 34 to be efficiently utilized, allows the configuration of the first lens unit 51 to be simplified, and can form a predetermined luminous flux distribution at the first slit unit 461 and the second slit unit 462. Furthermore, the lamp unit 20 can provide, through the second lens unit 52, the light from the second light source 35 to form a uniform luminous flux distribution for the third slit unit 463. As a result, despite using the single converging lens 23, the lamp unit 20 can form a different luminous flux distribution for each of the slit units 46, and can form a more appropriate illumination pattern Pi.

In the lamp unit 20, for the first lens unit 51, a convergence point of light that has passed through the facing incident surface 53 (second position P2) is set closer to the projection lens 25 than the shade 24, and a convergence point of light that has been reflected by the reflecting surface 55 (first position P1) is set closer to the projection lens 25 than the shade 24. In addition, in the lamp unit 20, for the second lens unit 52, a convergence point of the light from the second light source 35 (third position P3) is set closer to the projection lens 25 than the shade 24. Therefore, the lamp unit 20 can form a predetermined luminous flux distribution over the entire corresponding slit unit 46 on the shade 24 without excessively converging light, and can appropriately form the illumination pattern Pi.

In the lamp unit 20, for the first lens unit (51), the convergence point of light that has passed through the facing incident surface 53 (second position P2) is set closer to the shade 24 than the convergence point of light from the second light source 35 set for the second lens unit 52 (third position P3), and the convergence point of light that has been reflected by the reflecting surface 55 (first position P1) is set closer to the shade 24 than the convergence point of light that has passed through the facing incident surface 53 (second position P2). In this way, in the lamp unit 20, each of the above-mentioned convergence points can be adapted to provide suitable density and distribution of the luminous flux at each of the slit units 46 on the shade 24, and to prevent light from traveling to the peripheral unit of the projection lens 25, and thus the illumination pattern Pi can be appropriately formed with a simple configuration.

The vehicle lamp 10 includes the lamp unit 20 described above. Therefore, even if the lamp unit 20 is arranged to have the lamp unit axis Ar parallel to the vehicle axis, the vehicle lamp 10 can form an illumination pattern Pi in the vicinity of the vehicle 1, and the lamp unit 20 can be provided without increasing the size of the lamp chamber.

Therefore, the lamp unit 20 (the vehicle lamp 10) of the first example that is the lamp unit (vehicle lamp) according to the present disclosure can form the illumination pattern Pi in the vicinity of the driver's vehicle (vehicle 1) without increasing a dimension in the up-down direction.

The vehicle lamp of the present disclosure has been described above based on the first example, but the specific configuration is not limited to the first example. Thus, design modifications, additions, and the like may be performed without departing from the gist of the invention according to each claim.

In the first example, the three illumination figures Di each have a substantially rectangular shape with a shorter side facing the vehicle 1, and are arranged at substantially equal intervals in the direction away from the vehicle 1 to form the illumination pattern Pi. However, the illumination pattern is not limited to the configuration of the first example as long as the illumination pattern is formed by a plurality of illumination figures Di formed by a shade (light blocking member), and design or position of a symbol formed as the illumination figure Di, or the number of illumination figures Di, etc. may be set appropriately.

In the first example, each of the light sources (34, 35) emits white light. However, the color of the light emitted from the light source may be appropriately set according to the installation location and the content to be communicated, and is not limited to the configuration of the first example.

In the first example, the shade 24 is used as the light blocking member, and the light that has been converged by the converging lens 23 passes through each of the slit units 46. However, the light blocking member is not limited to the configuration of the first example, and may have another configuration as long as the light blocking member is provided with a plurality of slit units 46 allowing partial passage of the light that has been converged by the converging lens 23. As an alternative configuration, for example, a plate-shaped film member that blocks transmission of light and includes a plurality of slit units that allows partial passage of light may be used as a light blocking plate (filter) that allows passage of the light that has passed through the converging lens 23, through the plurality of slit units.

In the first example, the lamp unit 20 (vehicle lamp 10) is provided in the vehicle 1 driven by a driver. However, the vehicle lamp may be provided in a vehicle having an automatic driving function, and is not limited to the configuration of the first example. In this case, the vehicle lamp is not limited to the configuration of the first example, as long as an illumination pattern is formed at a timing according to intended use, that is, at a timing according to some kind of intention related to the operation of the vehicle 1.

In the first example, the lamp unit 20 is provided in the lamp chamber of the vehicle lamp 10. However, the lamp unit may be provided at any location in the vehicle and is not limited to the configuration of the first example, as long as the lamp unit has the above characteristics and is installed on the vehicle. Furthermore, the vehicle lamp 10 may include only the lamp unit 20 and is not limited to the configuration of the first example.

In the first example, two light sources 34 and 35 are provided. However, the number and arrangement of the light sources may be appropriately set as long as a plurality of light sources are provided, and are not limited to the configuration of the first example.

In the first example, the lamp unit axis Ar of the lamp unit 20 is parallel to the vehicle axis of the vehicle 1 on which the lamp unit 20 is installed. However, the lamp unit axis Ar may not be exactly parallel to the vehicle axis and may substantially parallel to the vehicle axis. Here, “substantially parallel” means that the angle formed by the lamp unit axis Ar and the vehicle axis is within 3 degrees, and preferably within 1 degree. Therefore, the lamp unit axis Ar may also be substantially parallel to the road surface 2, that is, may be inclined at an angle equal to or smaller than the upper limit of 3 degrees.

### DESCRIPTION OF REFERENCE NUMERALS

10 Vehicle lamp
20 Lamp unit
21 Installation base unit
23 Converging lens
24 Shade (example of light blocking member)
25 Projection lens
34 First light source
35 Second light source
461 First slit unit
462 Second slit unit
463 Third slit unit
51 First lens unit
52 Second lens unit
53 Facing incident surface
54 Inclined incident surface
55 Reflecting surface
Ar Lamp unit axis
C1 Center position
C2 Center position
C3 Center position
C4 Center position
Di1 First illumination figure
Di2 Second illumination figure
Di3 Third illumination figure
Ea Effective area
Fb Reference focal point
Ph Installation base unit reference point
Pi Illumination pattern
θ1 First inclination angle
θ2 Second inclination angle

1. A lamp unit, comprising: an installation base unit provided with a plurality of light sources; a converging lens that converges light from the plurality of light sources; a light blocking member provided with a plurality of slit units that allows partial passage of the light that has been converged by the converging lens; and a projection lens that projects the light that has passed through the light blocking member, to form an illumination pattern having a plurality of illumination figures corresponding to the plurality of slit units, the installation base unit, the converging lens, the light blocking member, and the projection lens being arranged along a lamp unit axis, wherein
the projection lens has a reference focal point set on the lamp unit axis,
the projection lens and the light blocking member are rotated downward about the reference focal point, and
the installation base unit and the converging lens are rotated downward about an installation base unit reference point set behind and above the reference focal point.

2. The lamp unit according to claim 1, wherein a first inclination angle of the projection lens and the light blocking member relative to the lamp unit axis is larger than a second inclination angle of the installation base unit and the converging lens relative to the lamp unit axis.

3. The lamp unit according to claim 2, wherein the reference focal point is provided between the projection lens and the light blocking member, and
the installation base unit reference point is provided between the installation base unit and the converging lens.

4. The lamp unit according to claim 3, wherein the second inclination angle is such that the light that has been converged by the converging lens and passed through the light blocking member is guided to an effective area of the projection lens.

5. The lamp unit according to claim 1, wherein the plurality of light sources are provided above the lamp unit axis, and
the plurality of slit units are provided above the lamp unit axis.

6. The lamp unit according to claim 5, wherein each of the light sources is provided correspondingly to at least one or more of the slit units, and
each of the light sources is provided above a center position of the corresponding at least one or more of the slit units.

7. The lamp unit according to claim 6, wherein the illumination figures include a first illumination figure projected at a distant position in the illumination pattern, a second illumination figure projected at a closer position than the first illumination figure in the illumination pattern, and a third illumination figure projected at a closer position than the second illumination figure in the illumination pattern,
the plurality of slit units include a first slit unit corresponding to the first illumination figure, a second slit unit corresponding to the second illumination figure, and a third slit unit corresponding to the third illumination figure, and
the light sources include a first light source corresponding to the first slit unit and the second slit unit, and a second light source corresponding to the third slit unit.

8. The lamp unit according to claim 7, wherein a center position of the first light source is located above a center position of an area in which the first slit unit and the second slit unit are provided, and
a center position of the second light source is located above a center position of the third slit unit.

9. The lamp unit according to claim 8, wherein the converging lens includes a first lens unit corresponding to the first light source and a second lens unit corresponding to the second light source, the first lens unit and the second lens unit being stacked,
the first lens unit has a facing incident surface facing the first light source, an inclined incident surface surrounding the facing incident surface, and a reflecting surface surrounding the inclined incident surface, and
the second lens unit is a convex lens that converges light from the corresponding second light source.

10. The lamp unit according to claim 9, wherein for the first lens unit, a convergence point of light that has passed through the facing incident surface is set closer to the projection lens than the light blocking member, and a convergence point of light that has been reflected by the reflecting surface is set closer to the projection lens than the light blocking member, and
for the second lens unit, a convergence point of the light from the second light source is set closer to the projection lens than the light blocking member.

11. The lamp unit according to claim 10, wherein for the first lens unit, the convergence point of light that has passed through the facing incident surface is set closer to the light blocking member than the convergence point of light from the second light source set for the second lens unit, and the convergence point of light that has been reflected by the reflecting surface is set closer to the light blocking member than the convergence point of light that has passed through the facing incident surface.

12. A vehicle lamp comprising the lamp unit according to claim 1.
